(19) United States
(12) Patent Application Publication
(10) Pub. No.: US 2016/0069375 A1
(43) Pub. Date: Mar. 10, 2016

(54) FIXED LENGTH FASTENER ASSEMBLY

(71) Applicant: Engineered Components Company, Elgin, IL (US)

(72) Inventor: Arne Henricksen, JR., Algonquin, IL (US)

(21) Appl. No.: 14/482,797

(22) Filed: Sep. 10, 2014

(51) Int. Cl. F16B 33/00; F16B 5/02

(52) U.S. Cl. CPC F16B 33/002; F16B 5/02

(57) ABSTRACT

A fastener assembly comprising a male fastener and female fastener. The male fastener includes a shaft that has a first portion with a shoulder and a second portion being threaded. The female fastener includes a shafted with a threaded bore to receive the threaded second portion of the shaft of the male fastener. At least one of the male fastener and the female fastener includes an outer surface with a machined surface and a forger surface, wherein the machined surface faces the other fastener when the two are engaged.

### BACKGROUND OF THE INVENTION

The present invention relates to a fastener assembly, and more particularly to a fastener assembly having a fixed minimum distance of engagement between a male and female fastener.

Fastener assemblies are typically used in the construction of trailers for trucks, for example, to attach wall panels to a frame or other structure to form a trailer body. More recently, the wall panels for trailers are being constructed from lightweight materials. Typically these lightweight materials comprise a honeycomb shaped body sandwiched between two layers of material (or skins) to form a lightweight panel. These lightweight panels are typically secured to the frame or other portion of a trailer body with a plurality of fastener assemblies. It has been found that conventional fastener assemblies can easily damage such lightweight panels during installation.

More specifically, while the lightweight panels have sufficient strength and structural integrity over the entire surface of each lightweight panel, the panels do not have enough strength to stop or slow the tightening of a fastener assembly. Thus, it is very common that a fastener assembly is overtightened during installation. When this occurs, the fastener assembly may crush, or otherwise damage, the lightweight panel.

Therefore, it would be desirable to have a fastener assembly that minimizes the unintended overtightening of the fastener assembly during installation.

Additionally, due to manufacturing processes like cold forming, there can be a large variance in the exact measurements of the produced fastener assemblies. While this tolerance level may be acceptable for certain applications, in applications where the overtightening of the fastener assembly could damage the objects being held together, the large tolerance level is not acceptable. While it is possible to produce fastener assemblies by machining processes which provide for lower more acceptable tolerances, it is believed that producing a large quantity of fully machined fastener assemblies would be very time consuming—as well as expensive.

Therefore, it would also be desirable to have a process that can efficiently produce fastener assemblies within a small tolerance level so that the chance that the fastener can or will be overtightened during installation is minimized.

### SUMMARY OF THE INVENTION

A new fastener assembly configured to secure together two or more objects and method of producing same have been invented.

Accordingly, in an aspect of the present invention, the invention comprises a fastener assembly which includes a male fastener having a head, a shaft, and an outer surface. The shaft of the male fastener includes a first portion and a second portion. The first portion includes a shoulder and is disposed between the second portion and the head of the male fastener. The second portion of the shaft is threaded and terminates in an end of the shaft. The fastener assembly also includes a female fastener having an outer surface, a head, and a shaft extending away from the head of the female fastener. The shaft of the female fastener includes a first end adjacent to the head of the female fastener and a second end having an aperture. An inner surface of the shaft of the female fastener is threaded. An outer surface of at least one fastener includes both a machined surface and a forged surface. The machined surface of the at least one fastener faces the other fastener when the two fasteners are engaged together.

In at least one embodiment, the at least one fastener with an outer surface having both a machined surface and a forged surface comprises the male fastener. It is contemplated that the shoulder of the first portion of the shaft of the male fastener comprises the machined surface.

In at least one embodiment, the at least one fastener with an outer surface having both a machined surface and a forged surface comprises the female fastener. It is contemplated that the second end of the shaft of the female fastener comprises the machined surface of the female fastener.

In some embodiments, both the male fastener and the female fastener include an outer surface that includes both a machined surface and a forged surface. It is contemplated in at least one embodiment that the shoulder of the first portion of the shaft of the male fastener comprises the machined surface of the male fastener and the second end of the shaft of the female fastener comprises the machined surface of the female fastener.

In one or more embodiments, the first portion of the shaft of the male fastener includes a perimeter and the second portion of the shaft of the male fastener includes a perimeter being smaller than the perimeter of the first portion of the shaft of the male fastener when viewed along a longitudinal axis of the male fastener. It is contemplated that the perimeter of the first portion of the shaft of the male fastener comprises a circle, and the perimeter of the second portion of the shaft of the male fastener comprises a circle.

In at least one embodiment, at least one of the head of the male fastener and the head of the female fastener includes a recess configured to receive a bit. It is contemplated that both the head of the male fastener and the head of the female fastener include a recess configured to receive a bit.

In some embodiments, the recess of the head of the female fastener may include an aperture sized to permit the end the shaft of the male fastener to pass into the recess.

In some embodiments, the head of the male fastener includes a perimeter and the head of the female faster includes a perimeter being the same size as the perimeter of the male fastener.

In at least one embodiment, the fastener assembly includes a second female fastener having a head and a shaft. The shaft of the second female fastener includes a first end adjacent to the head of the second female fastener and a second end having an aperture. An inner surface of the shaft of the second female fastener is threaded. A length of the shaft of the second female fastener is greater than a length of the shaft of the first female fastener. It is contemplated that the at least one fastener with an outer surface having a machined surface and a forged surface comprises the male fastener. It is further contemplated that the shoulder of the first portion of the shaft comprises the machined surface.

In another aspect of the present invention, the invention provides a fastener assembly comprising a male fastener with a head with an outer side and inner side and a shaft extending away from the inner side of the head. The shaft includes a portion terminating in a machined surface. The fastener assembly also includes a female fastener with a head with an inner side and an outer side and a shaft extending away from the inner side of the head. The shaft of the female fastener terminates in a machined surface. The inner side of the head of the male fastener and the inner side of the head of the female fastener are forged surfaces.

In another aspect of the present invention, the invention provides a trailer for a vehicle, having a wall secured to a frame with a plurality of fastener assemblies, wherein at least one fastener assembly comprises one of the fastener assemblies described herein. It is contemplated that a total tolerance of lengths of elements of the fasteners terminating in a machined surface for at least 40% of the fastener assemblies is +/−0.015 inches or smaller.

A fastener assembly according to one or more embodiments is believed to minimize the chance that the fastener assembly is overtightened and provides a process by which a large quantity of fastener assemblies could be efficiently produced.

### BRIEF DESCRIPTION OF THE DRAWINGS

The attached figures in the appended drawing will make it possible to understand the various embodiments of the present invention can be produced. In these figures, identical reference numbers denote similar elements.

FIG. 1 is a cross sectional view of a two component structure being secured with a fastener assembly according to one or more embodiments of the present invention.

FIG. 2 is a perspective view of a disassembled fastener assembly according to one or more embodiments of the present invention.

FIG. 3A is a top view of a first fastener of the fastener assembly shown in FIG. 2.

FIG. 3B is a bottom view of the first fastener of the fastener assembly shown in FIG. 2.

FIG. 3C is a side view of the first fastener of the fastener assembly shown in FIG. 2.

FIG. 4A is a top view of a second fastener of the fastener assembly shown in FIG. 2.

FIG. 4B is a bottom view of the second fastener of the fastener assembly shown in FIG. 2.

FIG. 4C is a side view of the second fastener of the fastener assembly shown in FIG. 2.

FIG. 4D is a side cutaway view of the second fastener of the fastener assembly shown in FIG. 2.

FIG. 5 is a fully assembled fastener assembly according to one or more embodiments of the present invention.

FIG. 6 is a side view of another fastener assembly according to one or more embodiments of the present invention.

### DETAILED DESCRIPTION OF THE PREFERRED EMBODIMENTS

With reference the attached drawings, one or more embodiments of the present invention will now be described with the understanding that the described embodiments are merely preferred and are not intended to be limiting.

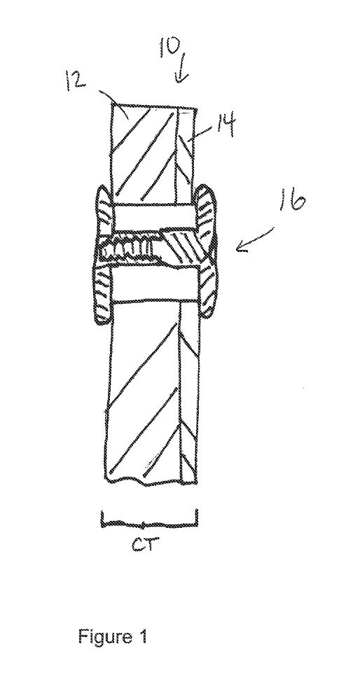

With reference to FIG. 1, a portion of a structure 10 (such as a container, portable shelter or truck body) is shown in which a material forming a first structural component 12, such as a wall panel, is secured to a second structural component 14, such as an extrusion or frame, by a plurality of fastener assemblies 16. Although only two components 12, 14 are shown, any number of two or greater structural components may be secured together with the fastener assembly 16 of the present invention. The structure 10 has a combined thickness CT that is preferably known.

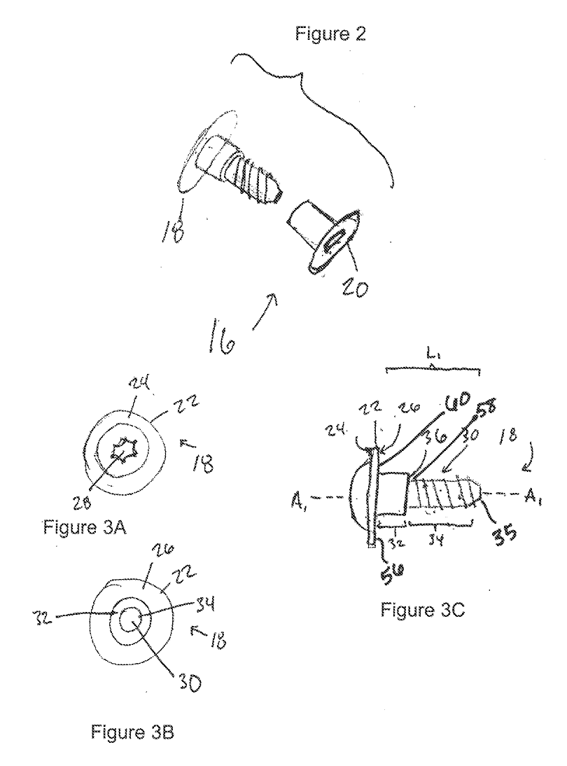

As shown in FIG. 2, each of the fastener assemblies 16 includes a male fastener 18 and a female fastener 20. The male fastener 18 may be in the form of a bolt. The female fastener 20 may be in the form of a T-nut.

With reference to FIGS. 3A to 3C, the male fastener 18 preferably includes a head portion 22 having an outer side 24 and an inner side 26. The outer side 24 of the head portion 22 of the male fastener 18 may be provided with a recessed portion 28 that is adapted to receive a tool for rotationally driving the male fastener 18. The recessed portion 28 as shown is adapted to receive a TORX® driving tool, but it is contemplated that the head portion 22 can be adapted or shaped to receive any suitable driving tool, such as a screwdriver, Allen wrench, or socket wrench.

As can be seen in FIG. 3C, the male fastener 18 also includes a shaft 30 extending away from the inner side 26 of the head portion 22. The shaft 30 of the male fastener 18 includes a first portion 32 and a second portion 34.

The first portion 32 of the shaft 30 is disposed between the head portion 22 and the second portion 34 of the shaft 30. The first portion 32 of the shaft 30 of the male fastener 18 includes a shoulder 36.

The second portion 34 of the shaft 30 is threaded and terminates at an end 35 of the shaft 30. It is also contemplated that the second portion 34 of the shaft 30 includes a microencapsulated patch material (not shown) which will set and cure after a certain amount of time once the two fasteners 18, 20 are engaged and will secure the male fastener 18 to the female fastener 20. These materials are known in the art.

As can be seen in FIG. 3B, it is preferred that an outer perimeter of the first portion 32 of the shaft 30 is greater than an outer perimeter of the second portion 34 of the shaft 30, when viewed along the longitudinal axis (A₁-A₁) of the male fastener 18. Preferably, these perimeters are both circles, but other shapes are contemplated as well.

A preferred male fastener 18 has an overall length L₁ of 0.625 inches +/−0.003 inches (measured from the inner side 26 of the head portion 22 to the end 35 of the shaft 30). As will be discussed in more detail below, the length of the first portion 32 of the shaft 30 is not necessarily important for the practicing of the present invention provided that at least three or four threads of the second portion 34 of the shaft are engaged with the female fastener 20 when the male fastener 18 is secured to the female fastener 20. It is preferred that the head portion 22 of the male fastener 18 has a generally circular shape (i.e., outer perimeter), preferably having a diameter between 0.75 inches to 1.5 inches, and most preferably a diameter of approximately 1.0 inches.

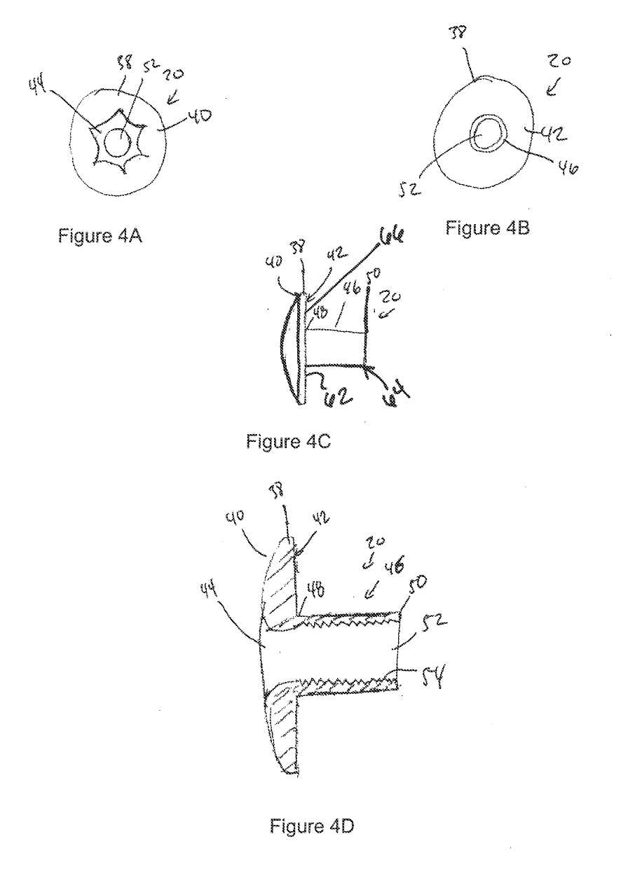

With reference to FIGS. 4A to 4D, the female fastener 20 of the fastener assembly 16 preferably includes a head portion 38 having an outer side 40 and an inner side 42. The outer side 40 of the head portion 38 of the female fastener 20 also may include a recessed portion 44 that is adapted to receive a tool, preferably, for rotationally driving the female fastener 20. The recessed portion 44 of the female fastener 20 may be the same as the recessed portion 28 of the male fastener 18. Such a design, where both fasteners 18, 20 include a recessed portion 28, 44, allows for fastener assemblies 16 that are reversible relative to the components being assembled, such as truck bodies. That is, either fastener 18, 20 could be assembled from the exterior of the truck body, while the other fastener is assembled from the interior of the truck body. While the recessed portion 44 of the female fastener 20 as shown is adapted to receive a TORX® driving tool, it is contemplated that the recessed portion 44 can be adapted or shaped to receive any suitable driving tool, such as a screwdriver, Allen wrench, or socket wrench.

As can be seen for example in FIGS. 4C and 4D, the female fastener 20 also includes a shaft 46 extending away from the inner side 42 of the head portion 38 of the female fastener 20. The shaft of the female fastener 20 includes a first end 48 adjacent the head portion 38 and a second end 50 with an aperture 52 sized to receive the shaft 30 of the male fastener 18. Additionally, as can be seen in FIG. 4D, an inner surface 54 of the shaft 46 of the female fastener 20 is threaded to engage with the second portion 34 of the shaft 30 of the male fastener 18. In a preferred embodiment, the aperture 52 extends from the second end 50 of the shaft 46 to the head portion 38 (forming a threaded bore). In a most preferred embodiment, the aperture 52 extends though the recessed portion 44 in the head portion 38 so that an object is capable of passing completely through the female fastener 20 (see, FIG. 4C).

It is preferred that the head portion 38 of the female fastener 20 has a generally circular shape (i.e., outer perimeter), preferably having a diameter between 0.75 inches to 1.5 inches, and most preferably a diameter of approximately 1.0 inches.

In operation, the shaft 30 of the male fastener 18 is inserted into the aperture 52 of the second end 50 of the shaft 46 of the female fastener 20. A driving tool is used to rotate at least one of the fasteners 18, 20, while a second driving tool may be used to hold the other of the fasteners 18, 20 against rotation.

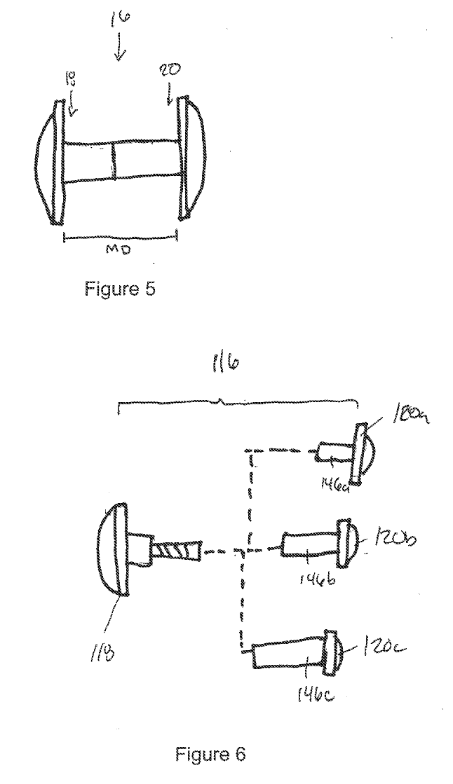

In some embodiments, the second end 52 of the shaft 46 of the female fastener 20 will eventually contact the shoulder 36 of the first portion 32 of the shaft 30 on the male fastener 18. The fasteners 18, 20 will be precluded from rotating further. As can be seen in FIG. 5, a minimum distance of engagement MD has been reached between the two fasteners 18, 20. The minimum distance of engagement MD is the distance between the inner sides 26, 42 of the head portions 22, 38 and preferably the minimum distance of engagement MD is less the combined thickness CT of the objects 12, 14 being held together (see, FIG. 1). Most preferably, the fasteners 18, 20 have provided a crush application (i.e., indented an inner surface of the objects being held together, for example the inner surface of the truck body) of approximately 0.030 inches.

As mentioned above, the relative lengths of the first portion 32 of the shaft 30 of the male fastener 18 and the shaft 46 of the female fastener 20 are not necessarily important so long as at least three or four threads of the second portion 34 the shaft 30 of the male fastener 18 are engaged with the threaded inner surface 54 of the shaft 46 of the female fastener 20 when the fastener assembly 16 is secured together for intended use. Additionally, the combined lengths of the first portion 32 of the shaft 30 of the male fastener 18 and the shaft 46 of the female fastener 20 will define the minimum distance of engagement MD.

In order to produce the fastener assemblies 16 so that a plurality of fasteners will consistently provide the desired crush application, each of the fasteners 18, 20, are first cold formed in a known manufacturing process. Then a portion of at least one fastener 18, 20 is adjusted to the appropriate desired length by machining, preferably an auto lathe. The outer surfaces of the fastener(s) that is adjusted by machining will include a machined surface and a forged surface. The machined surface will face the other fastener when the two fasteners are engaged.

It is preferred that a fastener assembly according to the present invention is produced with less than +/−0.015 inches total tolerance of the length of the component(s) of the fastener assembly that terminates in a machined surface. Most preferably, the total tolerance is less than +/−0.010. The tolerance provided by forging is believed to be approximately +/−0.003 inches. Accordingly, at least one fastener 18, 20 is adjusted by a machining process.

For example, in some embodiments, the male fastener 18 is adjusted by machining Accordingly, the male fastener 18 will have an outer surface 56 with a machined surface 58 and a forged surface 60. It is preferred that the shoulder 36 of the first portion 32 of the shaft 30 of the male fastener 18 is the machined surface 58. This will allow the production of male fastener 18 where the length of the first portion 32 of the shaft 30 (from the inner side 26 to the shoulder 36) with a tolerance of +/−0.003 inches.

In some embodiments, the female fastener 20 is adjusted by machining. Accordingly, the female fastener 20 will have an outer surface 62 with a machined surface 64 and a forged surface 66. It is preferred that the second end 50 of the shaft 46 of the female fastener 20 is the machined surface 64. This will allow for production of female fasteners 20 wherein the length of the shaft 46 of the female fastener 20 (from the inner surface 48 to the second end 50 of the shaft 46) with a tolerance of +/−0.0025 inches.

It is believed that by machining only a portion of a fastener, a large quantity of fasteners can quickly be produced with accurate and relatively consistent dimensions. If the fasteners were completely forged, the fluctuation of the lengths would be too great (i.e., the tolerance associated with forged surface would be too large, typically on the order of +/−0.003). Conversely, if the fastener assemblies were completely machined, it would take a long time to make the fastener assemblies and the cost would be much higher.

In order to accommodate various thicknesses of wall panels, such as from one type of truck body to another, or from one different truck manufacturer to another, it is contemplated that a fastener assembly is made in which one fastener type has a set length and the other fastener type is provided with a plurality of lengths.

As shown in FIG. 6, a single male fastener 118 is provided in the fastener assembly 116. A plurality of female fasteners 120a, 120b, 120c are provided. While in the depicted fastener assembly 116 there are three female fasteners 120a, 120b, 120c, any number of female fasteners greater than one may be used. Each female fastener 120a, 120b, 120c has a shaft 146a, 146b, 146c with a different length. Thus, the fastener assembly 116 may secure together various differently sized components having different combined thicknesses, while minimizing the chance of overtightening the fastener assembly 116 and damaging the components.

As mentioned above, a use for such a faster assembly is a trailer where a plurality of fastener assemblies can be used to secure a wall panel to a frame. It is contemplated that at least 40% of the fastener assemblies used for such a purpose on a trailer comprise a fastener assembly according to the embodiments discussed above. Preferably, at least 50% the fastener assemblies used for such a purpose on a trailer comprise a fastener assembly according to the embodiments discussed above. Most preferably, at least 90% of the fastener assemblies used for such a purpose on a trailer comprise a fastener assembly according to the embodiments discussed above.

It is believed that a fastener assembly according to one or more embodiments discussed above provides a fastener assembly that can securely hold together light weight panels used to construct the walls of, for example, a truck trailer, while minimizing the chance that the fastener assembly will be overtightened and the panels are damaged.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A fastener assembly comprising:
a male fastener having a head, a shaft, and an outer surface, the shaft of the male fastener including a first portion and a second portion, the first portion disposed between the second portion and the head of the male fastener, the first portion including a shoulder, and the second portion of the shaft being threaded and terminating in an end of the shaft; and,
a female fastener having an outer surface, a head, and a shaft extending away from the head, the shaft of the female fastener including a first end adjacent to the head of the female fastener and a second end having an aperture, an inner surface of the shaft of the female fastener being threaded;
wherein an outer surface of at least one fastener includes a machined surface and a forged surface, and wherein the machined surface of the at least one fastener faces the other fastener when the two fasteners are engaged.

2. The fastener assembly of claim 1 wherein the at least one fastener with an outer surface having a machined surface and a forged surface comprises the male fastener.

3. The fastener assembly of claim 2, wherein the shoulder of the first portion of the shaft of the male fastener comprises the machined surface.

4. The fastener assembly of claim 1 wherein both the male fastener and the female fastener include an outer surface that includes a machined surface and a forged surface.

5. The fastener assembly of claim 4, wherein the shoulder of the first portion of the shaft of the male fastener comprises the machined surface of the male fastener.

6. The fastener assembly of claim 5, wherein the second end of the shaft of the female fastener comprises the machined surface of the female fastener.

7. The fastener assembly of claim 1, wherein the at least one fastener with an outer surface having a machined surface and a forged surface comprises the female fastener.

8. The fastener assembly of claim 7, wherein the second end of the shaft of the female fastener comprises the machined surface of the female fastener.

9. The fastener assembly of claim 1 further comprising:
the first portion of the shaft of the male fastener including a perimeter and the second portion of the shaft of the male fastener including a perimeter being smaller than the perimeter of the first portion of the shaft of the male fastener when viewed along a longitudinal axis of the male fastener.

10. The fastener assembly of claim 9, wherein the perimeter of the first portion of the shaft of the male fastener comprises a circle, and the perimeter of the second portion of the shaft of the male fastener comprises a circle.

11. The fastener assembly of claim 1 further comprising:
at least one of the head of the male fastener and the head of the female fastener including a recess configured to receive a bit.

12. The fastener assembly of claim 11 wherein both the head of the male fastener and the head of the female fastener include a recess configured to receive a bit.

13. The fastener assembly of claim 1 further comprising:
the head of the female fastener including a recess configured to receive a bit, the recess including an aperture sized to permit an end of the second portion of the shaft of the male fastener to pass into the recess.

14. The fastener assembly of claim 1, wherein the head of the male fastener includes a perimeter and the head of the female faster includes a perimeter being the same size as the perimeter of the male fastener.

15. The fastener assembly of claim 1, further comprising:
a second female fastener having a head and a shaft, the shaft of the second female fastener including a first end adjacent to the head of the second female fastener and a second end having an aperture, an inner surface of the shaft of the second female fastener being threaded, and,
wherein a length of the shaft of the second female fastener is greater than a length of the shaft of the first female fastener.

16. The fastener assembly of claim 15 wherein the at least one fastener with an outer surface having a machined surface and a forged surface comprises the male fastener.

17. The fastener assembly of claim 16, wherein the shoulder of the first portion of the shaft comprises the machined surface.

18. A fastener assembly comprising:
a male fastener having a head with an outer side and inner side and a shaft extending away from the inner side of the head, the shaft including a portion terminating in a machined surface;
a female fastener having a head with an inner side and an outer side and a shaft extending away from the inner side of the head, the shaft of the female fastener terminating in a machined surface;
wherein the inner side of the head of the male fastener and the inner side of the head of the female fastener are forged surfaces.

19. A trailer for a vehicle, the trailer comprising:
a wall secured to a frame with a plurality of fastener assemblies,
wherein at least one fastener assembly comprises,
a male fastener having a head, a shaft, and an outer surface, the shaft of the male fastener including a first portion and a second portion, the first portion disposed between the second portion and the head of the male fastener, the first portion including a shoulder, and the second portion of the shaft being threaded and terminating in an end of the shaft; and,
a female fastener having an outer surface, a head, and a shaft extending away from the head, the shaft of the female fastener including a first end adjacent to the head of the female fastener and a second end having an aperture, an inner surface of the shaft of the female fastener being threaded;
wherein an outer surface of at least one fastener includes a machined surface and a forged surface, and wherein the machined surface of the at least one fastener faces the other fastener when the two fasteners are engaged.

20. The trailer of claim 19 wherein at least 40% of the fastener assemblies comprise:
a male fastener having a head, a shaft, and an outer surface, the shaft of the male fastener including a first portion and a second portion, the first portion disposed between the second portion and the head of the male fastener, the first portion including a shoulder, and the second portion of the shaft being threaded and terminating in an end of the shaft; and,
a female fastener having an outer surface, a head, and a shaft extending away from the head, the shaft of the female fastener including a first end adjacent to the head of the female fastener and a second end having an aperture, an inner surface of the shaft of the female fastener being threaded;
wherein an outer surface of at least one fastener includes a machined surface and a forged surface, and wherein the machined surface of the at least one fastener faces the other fastener when the two fasteners are engaged.
